(19) United States
(12) Patent Application Publication
(10) Pub. No.: US 2004/0059027 A1
(43) Pub. Date: Mar. 25, 2004

(54) Method of manufacturing and using thermal insulation for walls ceilings and floors of building structures containing rubber crumb and rubber shred and also using rubber crumb and rubber shred for fillers and sound inhibitors

(76) Inventor: Paul Steffonson, Airdrie (CA)

Correspondence Address: Paul Steffanson, Box 5238, Airdrie, T4B 2B3, CA

(21) Appl. No.: 10/179,257

(22) Filed: Sep. 19, 2002

(51) Int. Cl. C08K 3/00

(52) U.S. Cl. 524/8; 428/903.3

(57) ABSTRACT

Thermal insulation for walls, ceilings and floors of building structures, new and existing, containing rubber crumb and shred from discharged vehicle, implement and equipment tires. Also containing other rubber material; from both natural and synthetic sources.

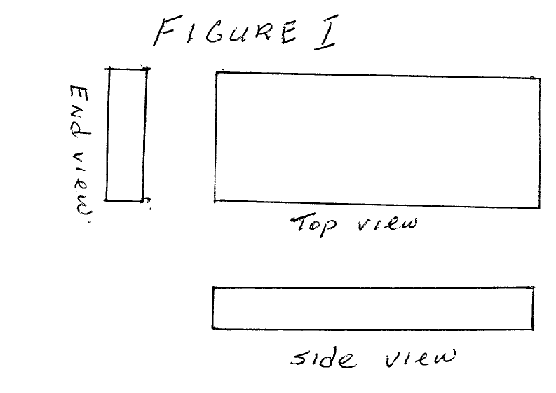

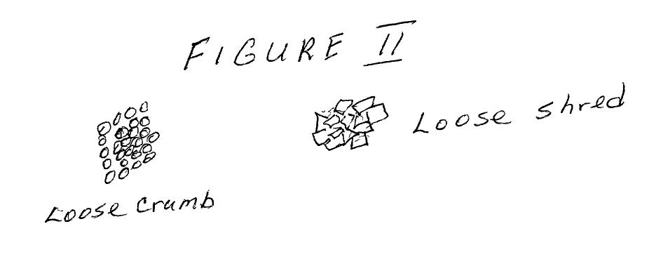

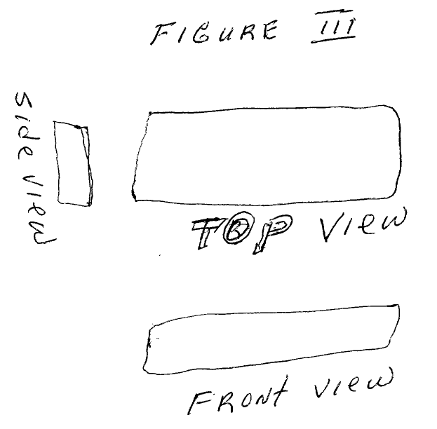

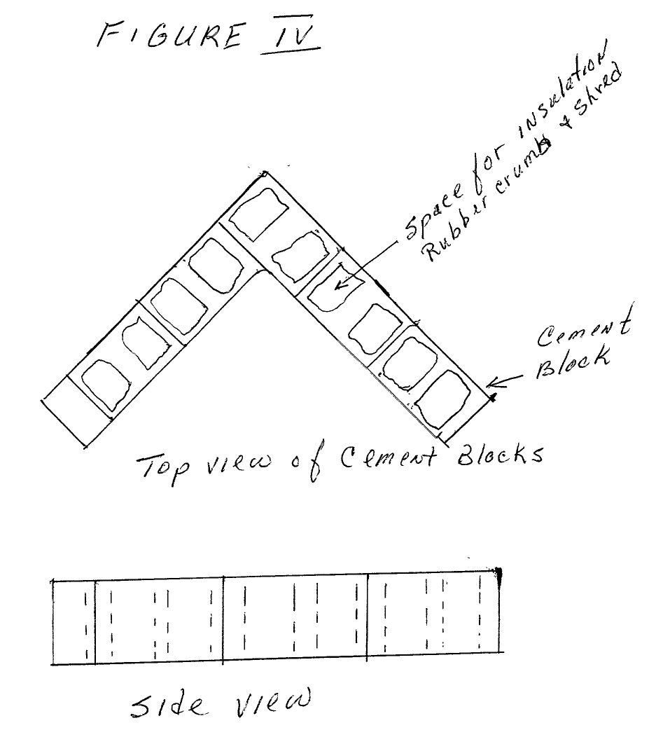

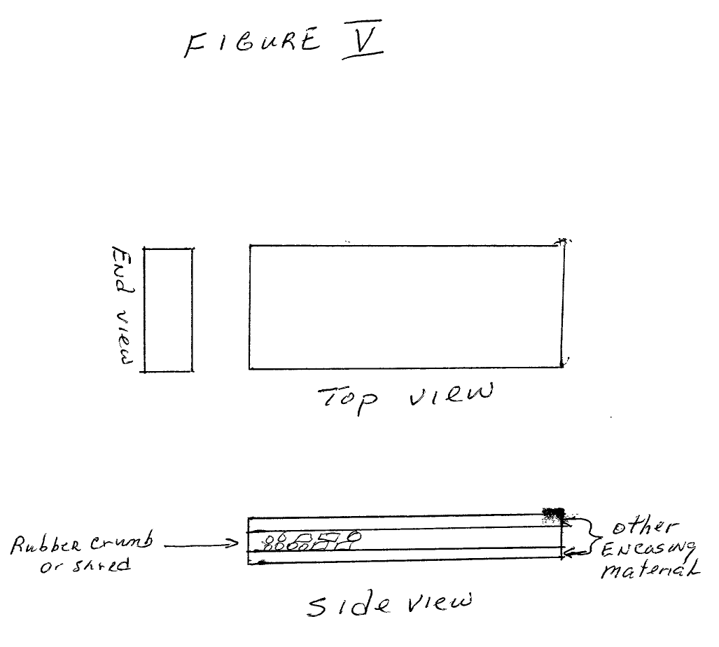

To this rubber type material will be added different compounds such as adhesives, pigment, fire retardant and fire repellants and other compounds.

Also Rubber Crumb and/or rubber shred to act as fillers, insulation sound inhibitors and provide elasticity flexibility etc., by using rubber crumb and/or rubber shred from discarded tires and other rubber material.

### FIELD OF INVENTION

The present invention relates to a method of manufacturing and using thermal insulation for walls ceilings and floors of building structures containing rubber crumb and rubber shred.

### BACKGROUND OF THE INVENTION

There is a need for good thermal insulation, fillers and sound inhibitors, which is competitive and viable, and rubber has good insulating qualities.

### SUMMARY OF THE INVENTION

Metod I

Incorporate rubber crumb and rubber shred with several different compound such as fire retardants, fire inhibitors, adhesives, pigment, stabilizers, compounds and other chemicals, then place these under heat and pressure to obtain a uniform wafer, pad, sheets and slabs of different sizes and thickness.

Method II

Taking loose Rubber crumb and rubber shred and placing into walls and above ceilings and floors. This can be deposited by hand or blown in by machine. Can be applied in new or existing buildings for walls ceilings and floors.

Method III

Incasing the rubber crumb and/or rubber shred into various containers made of plastic, cloth, wood, steel, paper, concrete, concrete blocks and other material including Styrofoam. May also add retardants, other compounds and heat and pressure

Method IV

Rubber crumb and rubber shred will also be incorporated into concrete walls, Styrofoam, wood and all material walls

Method V

Sandwiching the rubber crumb and rubber shred (other compounds may be incorporated) between the base and top layers of concrete in constructing floors driveways bases containers etc., figure V. This is done by spreading a layer of wet concrete of a certain thickness as a base, then spreading a layer of rubber crumb and/or rubber shred on top of the base, then spreading another layer of wet concrete on top as a finish and sealant.

Method VI

Also directly incorporating a specified amount of rubber crumb and/or rubber shred into the manufacture of concrete directly with the other ingredients to fully incorporate the rubber crumb and rubber shred into concrete for specific application and uses like elasticity, insulation, noise retardant etc.,

### BRIEF DESCRIPTION OF THE DRAWINGS

Figure I

Shows a diagram of a formed thermal insulation sheet, wafer, slab and pads made from rubber crumb and/or rubber shred and other compounds. These sheet wafers, slabs and pads will be manufactured to coincide with building structures as to width, length, and thickness. These will be in both metric and standard imperial sizes, also larger or smaller sizes will be manufactured for specific uses to accommodate many applications. Other compounds may be incorporated.

Figure II

Shows loose rubber shred and loose rubber crumb to be used for loose application between walls and above ceilings and under floors. The size of shred will vary depending on the application. Other compounds may also be incorporated.

Figure III

Shows loose rubber crumb and/or rubber shred into shred into different size containers made of different material such as plastic, cloth, wood, steel, paper, Styrofoam, felt, cork and any other suitable material. Other compounds may be incorporated.

Figure IV

Shows using rubber crumb and rubber shred in concrete walls by incorporating the material into spaces of concrete walls and blocks for insulation purposes and as fillers and sound inhibitors

Figure V

Shows sandwiching the rubber shred and rubber crumb (other compounds may be incorporated) between the base of a concrete floor, driveway roadway, concrete container etc. by placing the rubber crumb and rubber shred on top of the first layer (the base layer) and then applying another layer of concrete as the top layer (the finish layer)

Figure VI

Shows the direct incorporation of the rubber crumb and rubber shred (other compounds may be incorporated) into concrete as a filler, insulator, and to give it elasticity and flexibility on any or all applications especially as cement bases for motors and equipment to act as shock absorbers (to extend the life of machinery and prevent the concrete from cracking.

### DETAILED DESCRIPTION OF PREFERRED EMBODIMENT

I Incorporate rubber crumb and rubber shred with several different compound such as fire retardants, fire inhibitors, adhesives, pigment, stabilizers, compounds and other chemicals, then place these under heat and pressure to obtain a uniform wafer and sheets slab of different sizes and thickness. This is evidenced by Figure I.

II Taking loose Rubber crumb and rubber shred and placing into walls and above ceilings and floors as evidenced in Figure II. This can be deposited by hand or blown in by machine. Can be applied in new or existing buildings for walls ceilings and floors.

III Incasing the rubber crumb and/or rubber shred into various containers made of plastic, cloth, wood, steel, paper, concrete, concrete blocks and other material including Styrofoam. May also add retardants, other compounds and heat and pressure

IV Rubber crumb and rubber shred will also be incorporated into concrete walls, Styrofoam, wood and all material walls, Figure IV.

V Sandwiching the rubber crumb and rubber shred between the base and top layers of concrete in constructing floors driveways bases containers etc., Figure V. This is done by spreading a layer of wet concrete of a certain thickness as a base, then spreading a layer of rubber crumb and/or rubber shred on top of the base, then spreading another layer of wet concrete on top as a finish and sealant.

VI Also directly incorporating a specified amount of rubber crumb and/or rubber shred into the manufacture of concrete directly with the other ingredients to fully incorporate the rubber crumb and rubber shred into concrete for specific application and uses like elasticity, insulation, noise retardant etc., Figure VI.

1. That your petitioner made the invention entitled Method of Manufacturing and Using Thermal Insulation for Walls Ceilings and Floors of Building Structures Containing Rubber Crumb and Rubber Shred and Also using rubber crumb and rubber shred for Fillers and Sound Inhibitors which is described and claimed in the new specification submitted herewith.
